(19) United States
(12) Patent Application Publication
(10) Pub. No.: US 2025/0333047 A1
(43) Pub. Date: Oct. 30, 2025

(54) VEHICLE BATTERY POWER CAPABILITY

(71) Applicant: FORD GLOBAL TECHNOLOGIES, LLC, Dearborn, MI (US)

(72) Inventors: Yonghua LI, Ann Arbor, MI (US); Richard Dyche ANDERSON, Plymouth, MI (US); Matthew Allen TOMAI, Troy, MI (US); Elaine Y. CHEN, Dearborn, MI (US)

(21) Appl. No.: 18/647,382

(22) Filed: Apr. 26, 2024

(51) Int. Cl. B60W 20/13; B60K 6/26; B60K 6/28

(52) U.S. Cl. CPC B60W 20/13; B60K 6/26; B60K 2006/268; B60K 6/28; B60Y 2200/92; B60Y 2300/91; B60Y 2400/112; B60Y 2400/46

(57) ABSTRACT

A controller of a vehicle discharges power from a traction battery to an electric machine to propel the vehicle and charges the traction battery with power from the electric machine according to a value of a power capability parameter for the traction battery that corresponds to a time period selected by the controller.

### TECHNICAL FIELD

The present disclosure relates to a vehicle system and method for estimating a power capability of a vehicle battery and operating the vehicle according to the power capability.

### BACKGROUND

Electric vehicles (EVs) rely on one or more traction batteries to supply electric energy to a motor for propulsion. The driving operations of the vehicles may depend on the power capability of the traction batteries. The power capability may be affected by factors such as battery temperature, voltage, state of charge (SOC), battery age, and the like.

### SUMMARY

A vehicle power system includes a traction battery and a controller that discharges power from the traction battery at certain instances according to a value of a parameter indicative of power capability that corresponds to a default time period and at other instances according to a value of the parameter that corresponds to a time period specified by the controller.

A method includes discharging power from a traction battery according to a value of a power capability parameter that corresponds to a default time period, and discharging power from the traction battery according to a value of the power capability parameter that corresponds to a time period that is based on an expected duration of a vehicle operation.

A vehicle includes an electric machine, a traction battery, and a controller. The controller discharges power from the traction battery to the electric machine and charges the traction battery with power from the electric machine according to a value of a power capability parameter that corresponds to a time period specified by the controller.

### BRIEF DESCRIPTION OF THE DRAWINGS

FIG. 1 illustrates an example block topology of an electrified vehicle illustrating drivetrain and energy storage components.

FIG. 2 illustrates a block diagram of an arrangement for a traction battery controller of a battery electric vehicle (BEV) to monitor a traction battery of the BEV.

FIG. 3 illustrates a schematic diagram of a conventional equivalent circuit model (ECM) of the traction battery.

FIG. 4 illustrates a flow diagram of a process of the present disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for estimating a battery power capability for a specified time period, and operating the vehicle based on the power capability.

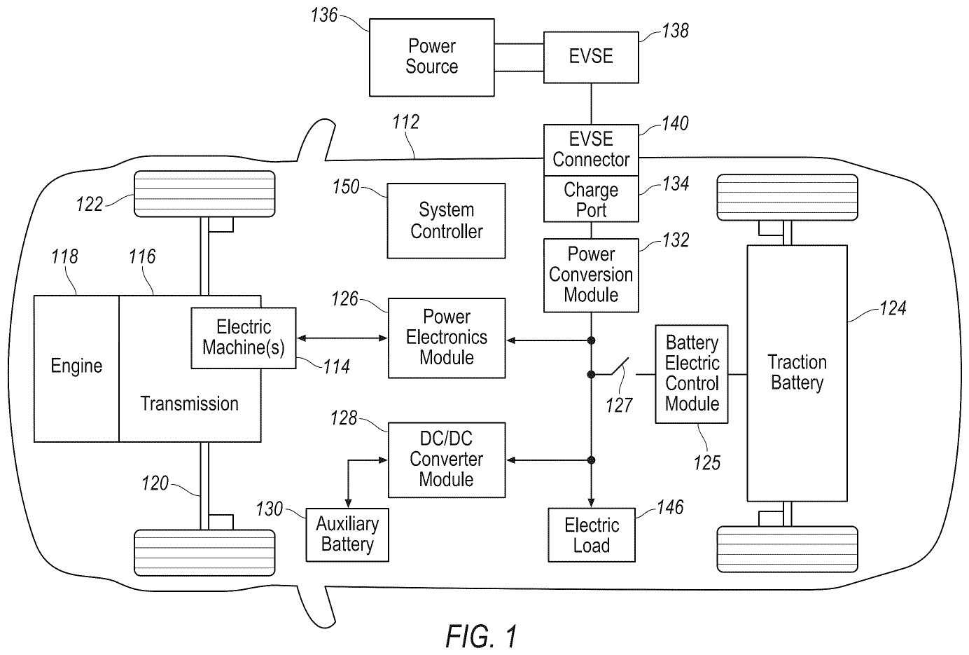

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to wheels 122. The electric machines 114 may provide propulsion and slowing capability when the engine 118 is turned on or off. The electric machines 114 may also function as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. Although a PHEV is used in the present example, the present disclosure is not limited thereto. The vehicle 112 may be a BEV, a hybrid electric vehicle (HEV), a fuel cell electric vehicle (FCEV), or any electrified vehicle having one or more high-voltage batteries.

A traction battery or battery pack 124 stores energy that may be used by the electric machines 114. The vehicle battery pack 124 may provide a high voltage DC output. The traction battery 124 may be electrically coupled to one or more battery energy control modules (BECM) 125. The BECM 125 may be a single unit or have a number of satellite sensing electronic control units (ECUs) that measure cell voltage and temperature and perform cell balancing functions. The battery pack level voltage measurements may be implemented in the BECM 125 or the satellite ECUs. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert three-phase AC current from the electric machines 114 acting as generators to DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include one or more DC/DC converter modules 128 that convert the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

As mentioned above, the vehicle 112 may be a BEV or a PHEV in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling. Although the vehicle 112 is illustrated as a BEV or PHEV with reference to FIG. 1, the present disclosure is not limited thereto.

One or more electrical loads 146 may be coupled to the high-voltage bus. The electrical loads 146 may have an associated controller that operates and controls the electrical loads 146 when appropriate. Examples of the electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g., a server) via a wireless network (e.g., a cellular network).

The system controller 150 and/or the BECM 125, individually or combined, may be programmed to perform various operations regarding the traction battery 124. The traction battery 124 may be a rechargeable battery made of one or more rechargeable cells (e.g., lithium-ion cells). For instance, the BECM 125 may be a traction battery controller operable for managing the charging and discharging of the traction battery 124 and for monitoring operating characteristics of the traction battery 124. The BECM 125 may be operable to implement algorithms to measure (e.g., detect or estimate) the operating characteristics of the traction battery 124. The BECM 125 may control the operation and performance of the traction battery 124 based on the operating characteristics. The operation and performance of other systems and components of the vehicle 112 may be controlled based on the operating characteristics of the traction battery 124 via the system controller 150.

Operating characteristics of the traction battery 124 may include various parameters. For instance, the operating characteristics may include the charge capacity and the SOC of the traction battery 124. The charge capacity of the traction battery 124 is indicative of the maximum amount of electrical energy that the traction battery 124 may store. The charge capacity may reduce over time as the traction battery 124 ages. The charge capacity reduction may be affected by factors such as the age and/or state of health (SOH) of the traction battery 124, the number of charging cycles, usage temperature, or the like. The SOC of the traction battery 124 is indicative of a present amount of electrical charge stored in the traction battery 124. The SOC of the traction battery 124 may be represented as a percentage of the maximum amount of electrical charge that may be stored in the traction battery 124. The operating characteristics may further include an internal resistance of the traction battery 124. Like the charge capacity, the internal resistance at a given temperature may vary as the battery ages. In general, the internal resistance increases as the battery becomes older.

Another operating characteristic of the traction battery 124 is the power capability of the traction battery 124. The power capability of the traction battery 124 is a measure of the maximum amount of power the traction battery 124 can provide (i.e., discharge) or receive (i.e., charge) for a specified time period. As such, the power capability of the traction battery 124 corresponds to discharge and charge power limits which define the amount of electrical power that may be supplied from or received by the traction battery 124 during the specified time period. In general, the power capability and the specified time period may be negatively correlated. Thus, for a shorter period of time, the traction battery 124 may provide a greater power capability. For a longer period of time, the traction battery 124 may provide a lesser power capability. These limits can be provided to other vehicle controls, for example, through the system controller 150, so that the information can be used by systems that may draw power from or provide power to the traction battery 124. Vehicle controls need to know how much power the traction battery 124 can provide (discharge) or receive (charge) to meet the driver's driving demand and vehicle high voltage load, such as the heating, ventilation and air conditioning demand, to optimize energy usage. As such, knowing the power capability of the traction battery 124 allows electrical loads and sources to be managed such that the power requested is within the allowed voltage and current limits that the traction battery can handle.

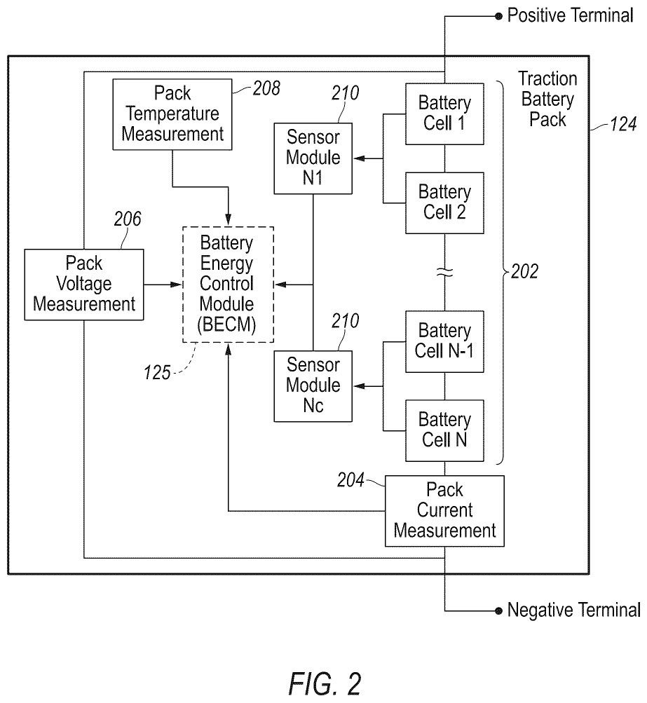

Referring to FIG. 2, with continuing reference to FIG. 1, a block diagram of an arrangement for the BECM 125 to monitor the traction battery 124 is illustrated. In the present example, the BECM 125 may be integrated with the traction battery 124 although the present disclosure is not limited thereto. The traction battery 124 includes a plurality of battery cells 202. The battery cells 202 may be physically connected (e.g., connected in series as illustrated in FIG. 2).

The BECM 125 may be operable to monitor pack level characteristics of the traction battery 124 such as battery current 204, battery pack voltage 206, and battery temperature 208. The battery current 204 is the current output (i.e., discharged) from or input (i.e., charged) to the traction battery 124. The battery pack voltage 206 is the terminal voltage of the traction battery 124.

The BECM 125 may also be operable to measure and monitor battery cell level characteristics of battery cells 202 of the traction battery 124. For example, terminal voltage, current, and temperature of one or more of battery cells 202 may be measured. The BECM 125 may use one or more battery sensors 210 to measure the battery cell level characteristics. The battery sensors 210 may measure the characteristics of one or multiple battery cells 202. The BECM 125 may utilize an Nc number of battery sensors 210 to measure the characteristics of all the battery cells 202. Each of the battery sensors 210 may transfer the measurements to the BECM 125 for further processing and coordination. In one embodiment, the battery sensors 210 functionality may be incorporated internally to the BECM 125.

The traction battery 124 may have one or more temperature sensors such as thermistors in communication with the BECM 125 to provide data indicative of the temperature of the battery cells 202 for the BECM 125. The vehicle 112 may further include one or more temperature sensors 208 to provide data indicative of ambient temperature for the BECM 125 to monitor the ambient temperature.

The BECM 125 may control the operation and performance of the traction battery 124 based on the monitored traction battery and battery cell level characteristics. For instance, the BECM 125 may use the monitored characteristics to measure (e.g., detect or estimate) operating characteristics of the traction battery 124 (e.g., the power capability, the SOC, the internal resistance, and the like) for use in controlling the traction battery 124 and/or vehicle 112.

As known by those of ordinary skill in the art, the BECM 125 may estimate values of parameters of an ECM (e.g., resistances and capacitances of circuit elements of the ECM) and values of states of the ECM (e.g., voltages and currents across circuit elements of the ECM) through recursive estimation based on such measurements. Alternatively, the current may be directly measured. For instance, the BECM 125 may use some adaptive estimation method, such as an extended Kalman filter (EKF), to estimate the values of the model parameters and model states.

For the values of the operating characteristics of the traction battery 124 measured by the BECM 125 to be accurate with the actual values of the operating characteristics of the traction battery 124, the ECM must accurately model the traction battery 124. For the ECM to accurately model the traction battery 124, the ECM must have an adequate set of parameters (e.g., resistances and capacitances of circuit elements of the ECM) and the estimated values of the model parameters and model states must be at least substantially similar to the values of the parameters and the states of an ECM that accurately model the traction battery 124 (i.e., the estimated parameter and state values have to be at least substantially similar to the actual parameter and state values).

An accurate model of the traction battery 124 enables the BECM 125 to accurately estimate the power capability and properly control the traction battery 124 which directly affects vehicle performance and driving range for a given full charge. ECMs are widely used in electrified vehicle traction battery control systems to satisfy real time control system requirements for calculation speed and RAM/ROM usage. Particularly, an n-RC ECM where n=1 or 2 is widely used. (An n-RC ECM is a type of ECM having “n” RC circuit elements each including a resistor (“R”) parameter and a capacitor (“C”) parameter; with n=1, a 1-RC ECM includes one such RC circuit element; and with n=2, a 2-RC ECM includes two such RC circuit elements). As indicated, the parameters for the ECM are learned with an online learning method such as Kalman Filter or EKF.

In accordance with the present disclosure, the BECM 125 employs an equivalent circuit model of the traction battery 124 that efficiently represents complex battery dynamics of the traction battery 124. The number of parameters of the proposed ECM are less than the number of parameters of multi-RC pair ECMs having three or more RC circuit elements, and the parameters of the proposed ECM can be learned using EKF or similar methods under reasonable BECM capabilities such as central processing unit utilization ratio and RAM/ROM availability.

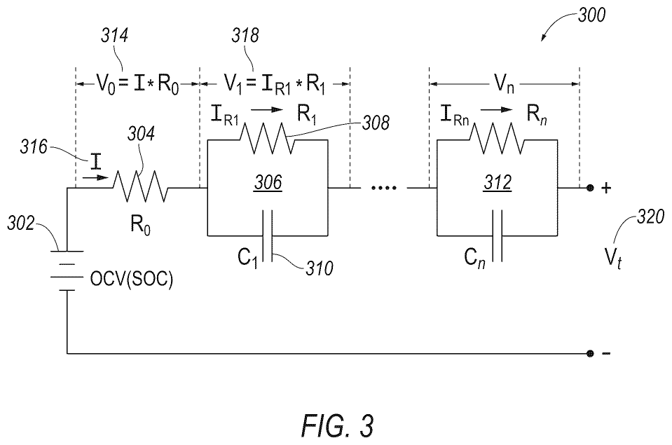

Referring now to FIG. 3, with continuing reference to FIGS. 1 and 2, a schematic diagram of an ECM 300 of the traction battery 124 is shown. Per the ECM 300, the traction battery 124 is modeled as a circuit having in series a voltage source (OCV/(SOC)) 302, a resistor R₀ 304, a first RC pair 306 having a first resistor R₁ 308 and a first capacitor C₁ 310 connected in parallel, and one or more such additional RC pairs 312. As such, the conventional ECM 300 is an n-RC ECM where n≥1.

The voltage source 302 represents the open-circuit voltage (OCV or V_{OC}) of the traction battery 124. The OCV of the traction battery 124 depends on the SOC, the temperature, and age of the traction battery 124. The resistor R₀ 304 represents an internal resistance of the traction battery 124. The RC pairs represent the diffusion process of the traction battery 124. As such, the diffusion process of the traction battery 124 in the conventional ECM 300 may be described with RC pairs R₁ and C₁, . . . , Rₙ and Cₙ.

Voltage V₀ 314 is the voltage drop across the resistor R₀ 304 due to battery current I 316 which flows across the resistor R₀ 304. Voltage V₁ 318 is the voltage drop across the first RC pair 306 due to battery current I_{R1} which flows across the resistor R₁ 308. A voltage drop is across each additional RC pair 312. Voltage Vₜ 320 is the voltage across the terminals of the traction battery 124 (i.e., the terminal voltage).

Parameters of the ECM 300 may include the resistors (i.e., resistor R₀, resistor R₁, and resistor Rₙ) and the capacitors (i.e., capacitor C₁ and capacitor Cₙ). The parameters are to have values whereby the calculated output of the ECM 300 in response to a hypothetical given input is representative of the actual output of the traction battery 124 in response to the actual given input. The values of the parameters can be learned online or locally by the BECM 125 such as with an EKF.

In the present example, the 1RC ECM (i.e., n=1) is used to describe the process of the present disclosure for simplicity. It is noted that the although the following description will be made with reference to the 1RC ECM, the present disclosure is not limited thereto. The present disclosure may be applied to any number of RC ECMs under essentially the same concept (e.g., n=1, 2, 3, 4, etc.). Referring to FIG. 3, a pair of governing equations of the 1RC ECM 300 may be written as follows:

$${\dot{V}}_{1} = - \frac{1}{{R}_{1} {C}_{1}} {V}_{1} + \frac{1}{{C}_{1}} I \qquad ( 1 )$$

$${V}_{OC} - {V}_{t} = {V}_{1} + {IR}_{1} \qquad ( 2 )$$

$$wherein {\dot{V}}_{1} = \frac{{d V}_{1}}{dt}$$

and denotes the time-based differential of V₁.

For any of the variables in these equations, there may be several different ways to determine them. For example, where the battery under consideration is a traction battery in an electric or hybrid electric vehicle, the battery current I and voltage Vₜ may be regularly measured at some predetermined frequency so that these values can be used by other vehicle control systems. In the case of an open circuit voltage V_{OC}, the value can be directly measured when the vehicle 112 is started before the main contactor 127 is closed. When the vehicle 112 is running, however, and the contactor 127 is closed, the open circuit voltage V_{OC} may not be directly measurable and thus needs to be estimated. There are various methods to estimate the open circuit voltage V_{OC}. For instance, the BECM 125 may estimate the open circuit voltage V_{OC} based on the SOC of the traction battery 124 using a lookup table and/or an algorithm stored onboard the vehicle 112. There may be several ways to determine the V_{OC} from the battery SOC; the method that is used may depend, for example, on whether the SOC is known for the traction battery 124 as a whole, or if the SOC is known for each of the individual battery cells 202. In the case where the SOC is known for each of the battery cells 202, the following equation may be used.

$${V}_{OC} = {\sum }_{i = 1}^{N} {V}_{OC \_ i} = {\sum }_{i = 1}^{N} f ( {SOC}_{i} ) \qquad ( 3 )$$

wherein N denotes the total number of the battery cells 202.

Based on the known SOC values for each battery cell, a corresponding V_{OC} value for each of the cells 202 may be determined using a lookup table or from some other known relationship between the V_{OC} and the SOC. Then, each of the calculated V_{OC} values for the individual battery cells 202 may be summed to provide the total V_{OC} for the traction battery 124. In the present example, it is assumed that the battery cells 202 are connected in series, thereby making their voltages additive. Calculating the V_{OC} in this matter provides a relatively accurate estimate of the battery V_{OC}, which cannot be directly measured.

To the extent the SOC for each of the individual battery cells 202 is not known, an alternative method to determine the V_{OC} for the traction battery 124 may be used as shown in the following equations:

$${V}_{OC} = N \times {V}_{OC \_ min} = N \times f ( {SOC}_{min} ) during discharge \qquad ( 4 )$$

$${V}_{OC} = N \times {V}_{OC \_ max} = N \times f ( {SOC}_{max} ) during charge \qquad ( 5 )$$

As shown in equations (4) and (5), there are two different versions of the battery pack V_{OC}: one for battery discharge (e.g., equation (4)), and another for battery charge (e.g., equation (5)). The reason for this is that there are two different battery power capabilities, one associated with battery discharge and another associated with battery charge. Each of these battery power capabilities are limited by different values of the V_{OC}. For example, the discharge battery power capability is limited by the minimum V_{OC} for the traction battery 124; whereas the charge battery power capability is limited by the maximum V_{OC} for the traction battery 124. Equations (4) and (5) may be used as an alternative to equation (3) even if the SOC for each of the battery cells 202 is known. In such a case, the lowest battery cell SOC may be used in equation (4), and the highest battery cell SOC may be used in equation (5). This has the advantage of speed and ease of calculation.

Although some of the variables occurring in equations (1) and (2) such as the current I and voltage Vₜ can be measured directly or estimated as described above, determination of other variables may require different means. For example, one way to determine values for at least some of the variables in equations (1) and (2) is to apply a Kalman filter to the equations. One way that a Kalman filter can be applied is to consider the current I as the input, the voltage V₁ as a state, and the term (V_{OC}−Vₜ) as the output. The circuit components R₀, R₁ and C₁ are also treated as states to be identified. The basic Kalman filter can be extended to estimate not only the states but also simultaneously estimate the circuit components. Once the circuit components and other unknowns are identified, the power capability can be calculated based on operating limits of a battery voltage and current, and the current battery state.

The first order differential equation from equations (1) and (2) can be solved to yield the following expression for the battery current I.

$$I ( {t}_{j} ) = \frac{( {V}_{OC} - {V}_{min} - {V}_{1} ( 0 ) {e}^{- \frac{{t}_{j}}{{R}_{1} {C}_{1}}} )}{[ {R}_{0} + {R}_{1} ( 1 - {e}^{- \frac{{t}_{j}}{{R}_{1} {C}_{1}}} ) ]} \qquad ( 6 )$$

wherein tⱼ denotes a predetermined time period during which the power capability is evaluated, V₁(0) denotes the value of V₁ at time 0, and e denotes the base of the natural logarithm.

In general, once the value for the current I from equation (6) is determined, the battery power capability can be estimated. For example, it may be desirable to determine a limiting battery current that is at least partly based on equation (6). Where it is desired to determine a discharge power capability for the battery, equation (6) may be solved for a maximum value of the current I, such as shown in the following equation. As used in the equations, discharge current is defined as a positive (+) quantity, and charge current is defined as a negative (−) quantity.

$${I}_{max} ( {t}_{j} , {V}_{min} ) = \frac{( {V}_{OC} - {V}_{t} - {V}_{1} ( 0 ) {e}^{- \frac{{t}_{j}}{{R}_{1} {C}_{1}}} )}{[ {R}_{0} + {R}_{1} ( 1 - {e}^{- \frac{{t}_{j}}{{R}_{1} {C}_{1}}} ) ]} \qquad ( 7 )$$

wherein Vₘᵢₙ denotes the minimum operating voltage of the traction battery 124 and may be considered a limiting battery voltage. The value of tⱼ is predetermined. As an example, the value of tⱼ may be set between 0.5 second and 10 seconds.

The time value tⱼ may be based on factors such as the battery usage history and the usage of the load or loads attached to the traction battery 124. The voltage Vₘᵢₙ may be determined by a vehicle manufacturer or a battery manufacturer as the minimum voltage the battery is allowed to reach.

Rather than using the maximum current value Iₘₐₓ without further examination, embodiments of the present disclosure compare the maximum current Iₘₐₓ to a discharge limit current I_{dch_lim} to determine if Iₘₐₓ is less than or equal to I_{dch_lim}. The reason for this is that the discharge limit current I_{dch_lim} may provide a boundary that is lower than the maximum current Iₘₐₓ. Specifically, the physical characteristics of systems associated with the battery may not be able to receive the full maximum current Imax, for example, wiring associated with the traction battery 124 or a fuse associated with a battery may require a current that is lower than the calculated value of Iₘₐₓ. In such a case, the discharge limit current I_{dch_lim} can be substituted for the maximum current Iₘₐₓ. This produces the following equation.

$${I}_{dch \_ lim} = \frac{( {V}_{OC} - {\overline{V}}_{dch} - {V}_{1} ( 0 ) {e}^{- \frac{{t}_{j}}{{R}_{1} {C}_{1}}} )}{[ {R}_{0} + {R}_{1} ( 1 - {e}^{- \frac{{t}_{j}}{{R}_{1} {c}_{1}}} ) ]} \qquad ( 8 )$$

As shown in equation (8), the value of the minimum voltage Vₘᵢₙ that was in Equation (7) is replaced with a discharge voltage ν̅_{dch}. Unlike the minimum battery voltage Vₘᵢₙ, the discharge voltage ν̅_{dch} is not readily known to the BECM 125. The discharge voltage ν̅_{dch} may be calculated using the following equation using the discharge limit current I_{dch_lim} as the input.

$${\overline{V}}_{dch} = {V}_{OC} - {V}_{1} ( 0 ) {e}^{- \frac{{t}_{j}}{{R}_{1} {C}_{1}}} - {I}_{dch \_ lim} * [ {R}_{0} + {R}_{1} ( 1 - {e}^{- \frac{{t}_{j}}{{R}_{1} {C}_{1}}} ) ] \qquad ( 9 )$$

Therefore, the discharge power capability of the traction battery 124 as a function of time tⱼ may be determined as follows:

$${P}_{cap \_ dch} ( {t}_{j} ) = \{ \begin{matrix}{I}_{max} * {V}_{min} & if {I}_{max} < {I}_{dch \_ lim} \\ {I}_{dch \_ lim} * {\overline{V}}_{dch} & otherwise\end{matrix} \qquad ( 10 )$$

wherein Vₘₐₓ denotes the maximum operating voltage of the traction battery 124.

In addition to determining a discharge power capability for the traction battery 124, the charge power capability may also be determined. A minimum value of the battery current Iₘᵢₙ may be used in conjunction with a minimum value of the battery voltage. The minimum current Iₘᵢₙ may be determined based on the above equation (6) as follows:

$${I}_{min} ( {t}_{j} , {V}_{max} ) = \frac{( {V}_{OC} - {V}_{max} - {V}_{1} ( 0 ) {e}^{- \frac{{t}_{j}}{{R}_{1} {C}_{1}}} )}{[ {R}_{0} + {R}_{1} ( 1 - {e}^{- \frac{{t}_{j}}{{R}_{1} {C}_{1}}} ) ]} \qquad ( 11 )$$

wherein Vₘₐₓ denotes the maximum operating voltage of the traction battery 124.

If this were the end of the inquiry, equation (11) could be solved for equation (10) and this value multiplied by the maximum voltage Vₘₐₓ to get the charge power capability. Just as on the discharge side however, a limiting value for the current may be determined. In this case, the minimum current Iₘᵢₙ may be compared to a charge limit current to see which value is greater. In the case where minimum current Iₘᵢₙ is greater than the charge limit current, the minimum current Iₘᵢₙ will be used to determine the charge power capability. Conversely, if the charge limit current I_{ch_lim} is greater than minimum current Iₘᵢₙ, then the charge limit current I_{ch_lim} will be used in determining the charge power capability. Like the discharge power capability analysis, a charge voltage (ν̅_{ch}) may be determined below:

$${I}_{ch \_ lim} = \frac{( {V}_{OC} - {\overline{V}}_{ch} - {V}_{1} ( 0 ) {e}^{- \frac{{t}_{j}}{{R}_{1} {C}_{1}}} )}{[ {R}_{0} + {R}_{1} ( 1 - {e}^{- \frac{{t}_{j}}{{R}_{1} {c}_{1}}} ) ]} \qquad ( 12 )$$

Since the value of the charge limit current I_{ch_lim} is known to the BECM 125, the above equation (12) may be rearranged and developed into:

$${\overline{V}}_{ch} = {V}_{OC} - {V}_{1} ( 0 ) {e}^{- \frac{{t}_{j}}{{R}_{1} {C}_{1}}} - {I}_{ch \_ lim} * [ {R}_{0} + {R}_{1} ( 1 - {e}^{- \frac{{t}_{j}}{{R}_{1} {C}_{1}}} ) ] \qquad ( 13 )$$

In summary, a limiting battery current can be defined as the greater of the minimum current Iₘᵢₙ and the charge limit current I_{ch_lim}. Thus, the charge power capability for a battery can be expressed as follows.

$${P}_{cap \_ ch} ( {t}_{j} ) = \{ \begin{matrix}\vert {I}_{mim} \vert * {V}_{max} & if {I}_{min} < {I}_{ch \_ lim} \\ \vert {I}_{ch \_ lim} \vert * {\overline{V}}_{ch} & otherwise\end{matrix} \qquad ( 14 )$$

As discussed above, the time period tⱼ during which the power capability is evaluated may be predetermined depending on various factors. Indeed, the system controller 150 may request different lengths of specified time periods for evaluating the power capability depending on factors such as the current and anticipated vehicle operations. Generally, the power capability and the specified time period may be negatively correlated for most vehicles. A shorter period of time may be associated with a greater power capability than the traction battery 124 may provide (e.g., hybrid vehicle anticipated to start the engine). A longer period of time may be associated with a lesser power capability than the traction battery 124 may provide (e.g., electric machine maintaining current vehicle speed for propulsion). In the present disclosure, the vehicle 112 may be associated with a longest time period t_{long} during which the power capability may be evaluated (e.g., 30 to 60 seconds). The longest time period t_{long} may depend on various factors. For instance, the longest time period t_{long} may be a predefined value by type of the vehicle 112. A smaller capacity traction battery 124 (e.g., of a hybrid vehicle) may be associated with a shorter t_{long} compared with a larger capacity traction battery 124 (e.g., of a PHEV or BEV). Additionally or alternatively, the longest time period t_{long} may be adjusted based on the battery dynamics such as SOH, total capacity, internal resistance, or the like. For instance, as the battery ages and the SOH decreases, the longest time period t_{long} may reduce.

As a few non-limiting examples, a BEV may request the power capability for a longer time period when the battery temperature is low, the drive power demand is high, and/or the battery SOC is close to zero (e.g., <5%) to protect the traction battery from over discharge.

In an alternative example, multiple duration power capability estimation may be applicable in gear shifting of multi-speed transmissions of the vehicle 112. Shifting gears may result in a charge pulse when upshifting and a discharge pulse when downshifting and therefore the driving operations of the vehicle 112 may need to be adjusted accordingly. For instance, if the charge pulse is generated in situations such as at high SOC and cold temperatures, the traction battery 124 may have limited power capability to accommodate the charge pulse.

In an alternative example, in case the vehicle 112 is a HEV or PHEV, the vehicle 112 may drive with the engine on or off. For instance, if the vehicle 112 is operating in the EV mode (e.g., engine off) on high power and an additional request to start the engine is made, the traction battery 124 may have insufficient power to satisfy the engine start demand and therefore a corresponding adjustment of the vehicle operation may be required.

In an alternative example, the vehicle 112 may be a FCEV. The traction battery 124 of the FCEV 112 may be charged in a fast manner (e.g., up to 2 C). The charging power may be adjusted depending on factors such as SOC. For example, as the SOC increases the charging power may be reduced. Multiple duration charge power capability may be required to perform vehicle controls managing the fast charging.

The system controller 150 may request the BECM 125 to provide a charge/discharge power capability for any length of time period within the longest time period t_{long} depending on the current and anticipated vehicle operation. Alternatively, the BECM 125 may provide the charge/discharge power capability of the longest time period t_{long} to the system controller 150 in a live manner without requiring receipt of the request from the system controller 150. In response to receiving the live data, the system controller 150 may select the power capability of a specified length of time based on the current and anticipated vehicle operation. For instance, the vehicle 112 may be associated with the longest time period of 60 seconds, and the system controller may request a discharge power capability for 25 seconds in the near future. Most of the time, the vehicle controller 150 may use a number of specific time period power capabilities depending on vehicle and battery operating conditions. To this end, the BECM 125 may divide the longest time period t_{long} into multiple steps tₛₜₑₚ and estimate the power capability corresponding to each step individually. For instance, if the longest time period t_{long} is 60 seconds, and each step tₛₜₑₚ is one second, the longest time period t_{long} may be divided into sixty steps (e.g., N=60). The BECM 125 may estimate the power capability for a time period corresponding to each of the sixty steps and generate the power capability for the longest time period t_{long} based on the sixty results. The specified period of time tⱼ may be equal or less than the longest time period t_{long}. For instance, the specific time period tⱼ may be any length between the step time tₛₜₑₚ and the longest time period t_{long}. The BECM 125 may determine the power capability corresponding to the specified time period tⱼ based on the specific vehicle condition. Continuing with the above example, the BECM 125 may designate the shortest specified time period as equal to the step time tₛₜₑₚ with one second increments until the specified time period is equal to the longest time period t_{long}. Thus, the BECM 125 may determine the power capability for 60 specified time periods (e.g., tⱼ=1 s, tⱼ=2 s, tⱼ=3 s, . . . , tⱼ=60 s). Each of the 60 power capabilities may be fed to the vehicle controller 150 as live data. In this case, the power capability of the longest time period t_{long} (which is equal to tⱼ when j=60) is directly fed to the vehicle controller 150.

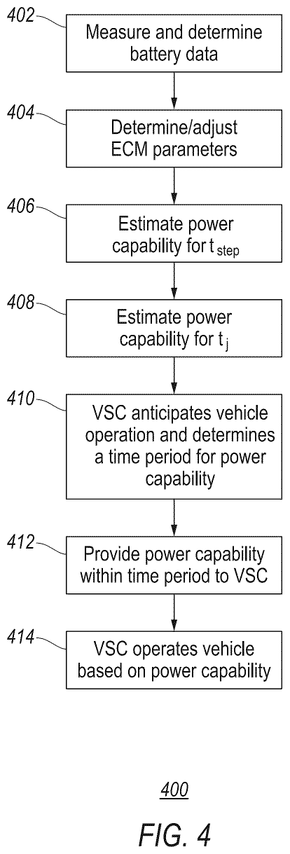

Referring to FIG. 4, an example flow diagram of a process 400 for operating the vehicle 112 based on the power capability of one embodiment of the present disclosure is illustrated. With continuing reference to FIGS. 1 to 3, the process 400 may be implemented in various components of the vehicle 112. For instance, the process 400 may be individually or collectively implemented via the BECM 125 and/or vehicle system controller 150 of the vehicle 112. For simplicity, the following description will be made primarily with reference to the BECM 125.

At operation 402, the BECM 125 measures and determines various battery data that may be used to establish the ECM 300 and perform the power capability estimation. Some vehicle data may be directly (or indirectly) measured by one or more sensors. For instance, the BECM 125 may measure the battery voltage Vₜ, current I, and battery temperature T via the corresponding sensors. Using the example from above, the voltage Vₜ and current I may be applied to equation (2) along with application of a Kalman filter to solve for the battery current I for the time step tⱼ shown in equation (6). Additionally, some battery data may not be directly measurable. For instance, the SOC of the traction battery 124 may be estimated from other measurable vehicle data.

At operation 404, the BECM 125 establishes and adjusts the ECM 300 based on the battery data previously measured and/or determined at operation 402. The various parameters of the ECM 300 may be adjusted based on the vehicle data. For instance, the open circuit voltage V_{OC} of the ECM 300 may be determined.

At operation 406, the BECM 125 estimates the power capability of the traction battery 124 based on the ECM 300 and equations (11) and (14) discussed above. In addition, the BECM 125 may apply various predetermined data including the discharge current limit I_{dch_lim}, the discharge voltage limit V_{dch_lim}, the charge current limit I_{ch_lim}, and the charge voltage limit V_{ch_lim} to the equations to estimate the discharge power capability P_{cap_dch} and charge power capability P_{cap_ch} for a step period of time tₛₜₑₚ.

The BECM 125 may repeat the operations 402 to 406 to determine the power capability P_{cap} for each step period of time tₛₜₑₚ. At operation 408, the BECM 125 estimates the power capability P_{cap} for each specified time period tⱼ which includes the longest time period t_{long}.

As discussed above, the power capability P_{cap} may be provided from the BECM 125 to the system controller 150 in an on demand manner. At operation 410, the system controller 150 monitors the vehicle operations and anticipates an event during which the battery power capability P_{cap} is required. The system controller 150 may specify a time period tⱼ corresponding to the anticipated power capability P_{cap} usage and send a request to the BECM 125. As discussed above, the specified time period tⱼ may be a time shorter or equal to the longest time period t_{long}. The request may include the specified time period.

At operation 412, in response to the request, the BECM 125 provides the estimates of the power capability P_{cap} for the specified time period tⱼ to the system controller 150 to facilitate the vehicle operation controls. Alternatively, the BECM 125 may be configured to continuously provide the power capability P_{cap} corresponding to a longest time period t_{long} to the system controller 150 without requiring receiving the request from the system controller.

At operation 414, in response to receiving the power capability, the system controller 150 performs the vehicle operation based on the power capability corresponding to the specified time period tⱼ. Thus, within the specified time period tⱼ, the system controller 150 operates the vehicle 112 consistent with the charge and/or discharge power capability of the traction battery 124. The maximum charge and/or discharge power during the specified period may be limited to the power capability.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers, for example, may be interchanged herein as the operations performed by a single controller may be distributed across a plurality of controllers that are in communication with each other.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, case of assembly, etc. As such, embodiments described as less desirable than other embodiments or prior art implementations with respect to one or more characteristics are not outside the scope of the disclosure and may be desirable for particular applications.

What is claimed is:

1. A vehicle power system comprising:
a traction battery; and
a controller programmed to discharge power from the traction battery at certain instances according to a value of a parameter indicative of power capability that corresponds to a default time period and at other instances according to a value of the parameter that corresponds to a time period specified by the controller.

2. The vehicle power system of claim 1, wherein the time period specified by the controller is less than the default time period.

3. The vehicle power system of claim 1, wherein the value of the parameter that corresponds to the default time period is less than the value of the parameter that corresponds to the time period specified by the controller.

4. The vehicle power system of claim 1, wherein the time period specified by the controller is based on an expected duration of a vehicle operation.

5. The vehicle power system of claim 4, wherein the vehicle operation is operating an electric machine to start an engine.

6. The vehicle power system of claim 4, wherein the time period specified by the controller is based on temperature data.

7. The vehicle power system of claim 4, wherein the time period specified by the controller is based on a state of charge of the traction battery.

8. A method comprising:
discharging power from a traction battery according to a value of a power capability parameter that corresponds to a default time period; and
discharging power from the traction battery according to a value of the power capability parameter that corresponds to a time period that is based on an expected duration of a vehicle operation.

9. The method of claim 8, wherein the vehicle operation is starting an engine with an electric machine.

10. The method of claim 8, wherein the time period is further based on temperature data.

11. The method of claim 8, wherein the time period is further based on a state of charge of the traction battery.

12. The method of claim 8 wherein the time period is less than the default time period.

13. A vehicle comprising:
an electric machine;
a traction battery; and
a controller programmed to discharge power from the traction battery to the electric machine and to charge the traction battery with power from the electric machine according to a value of a power capability parameter that corresponds to a time period selected by the controller.

14. The vehicle of claim 13, wherein the controller is further programmed to discharge power from the traction battery to the electric machine and to charge the traction battery with power from the electric machine according to a value of the power capability parameter that corresponds to a default time period.

15. The vehicle of claim 14, wherein the time period selected by the controller is less than the default time period.

16. The vehicle of claim 14, wherein the value of the power capability parameter that corresponds to the default time period is less than the value of the power capability parameter that corresponds to the time period selected by the controller.

17. The vehicle of claim 13, wherein the time period selected by the controller is based on temperature data.

18. The vehicle of claim 13, wherein the time period selected by the controller is based on a state of charge of the traction battery.
